(19) United States
(12) Patent Application Publication
(10) Pub. No.: US 2022/0222922 A1
(43) Pub. Date: Jul. 14, 2022

(54) OBJECT RECOGNITION METHODS AND DEVICES, AND STORAGE MEDIA

(71) Applicant: Beijing Sensetime Technology Development Co., Ltd., Beijing (CN)

(72) Inventors: Xinge ZHU, Beijing (CN); Tai WANG, Beijing (CN); Yan XU, Beijing (CN); Jianping SHI, Beijing (CN); Dahua LIN, Beijing (CN)

(21) Appl. No.: 17/711,627

(22) Filed: Apr. 1, 2022

Related U.S. Application Data
(63) Continuation of application No. PCT/CN2020/126485, filed on Nov. 4, 2020.

(30) Foreign Application Priority Data
Jan. 15, 2020 (CN) 202010043515.5

(51) Int. Cl. G06V 10/764; G06V 10/74; G06V 10/46; G06T 7/68

(52) U.S. Cl. CPC G06V 10/764; G06V 10/761; G01S 13/89; G06T 7/68; G06T 2207/10028; G06V 10/46

(57) ABSTRACT

Object recognition methods and devices, and storage media are provided. In one aspect, an object recognition method includes: acquiring to-be-processed point cloud data and processing the to-be-processed point cloud data to obtain target point cloud data, the to-be-processed point cloud data including point cloud data of an to-be-recognized object; recognizing the to-be-recognized object from the target point cloud data and determining a target feature of the to-be-recognized object; and determining, according to the target feature, a target category to which the to-be-recognized object belongs among a plurality of categories to obtain a recognition result for the to-be-recognized object. The recognition result includes at least the target category.

### CROSS-REFERENCE TO RELATED APPLICATIONS

The present application is a continuation application of International Application No. PCT/CN2020/126485 filed on Nov. 4, 2020, which claims a priority of the Chinese patent application No. 202010043515.5 filed on Jan. 15, 2020, all of which are incorporated herein by reference in their entireties.

### TECHNICAL FIELD

The present application relates to the field of computer vision technology, and in particular to an object recognition method and device, and a storage medium.

### BACKGROUND

Most of the current object recognition methods focus on single-category object recognition, and there are relatively few explorations for multi-category object recognition, especially on point cloud data. Because the point cloud data has some unique characteristics and limitations, such as having no texture and color, it makes the multi-category object recognition more difficult.

### SUMMARY

One aspect of the present application features an object recognition method, including: acquiring to-be-processed point cloud data, and processing the to-be-processed point cloud data to obtain target point cloud data, where the to-be-processed point cloud data includes point cloud data of a to-be-recognized object; recognizing the to-be-recognized object from the target point cloud data, and determining a target feature of the to-be-recognized object; and determining, according to the target feature, a target category to which the to-be-recognized object belongs among a plurality of categories to obtain a recognition result for the to-be-recognized object, where the recognition result includes at least the target category.

In some embodiments, processing the to-be-processed point cloud data to obtain the target point cloud data includes: traversing the to-be-processed point cloud data through a target geometry at a target step length to obtain the target point cloud data, where the target geometry has the same dimension as the to-be-processed point cloud data, and the target geometry includes a regularly-shaped geometry.

In some embodiments, traversing the to-be-processed point cloud data through the target geometry at the target step length to obtain the target point cloud data includes: scanning the to-be-processed point cloud data by moving the target geometry over the to-be-processed point cloud data at the target step length; during the movement of the target geometry, extracting non-overlapped point cloud data covered by the target geometry; and obtaining the target point cloud data according to the extracted non-overlapped point cloud data covered by the target geometry.

In some embodiments, objects belonging to different categories have different head shapes, and determining, according to the target feature, the target category to which the to-be-recognized object belongs among the plurality of categories includes: for each of the plurality of categories, determining, according to the target feature, a similarity between a head shape of the to-be-recognized object and a head shape corresponding to the category to obtain a respective similarity; and determining a category corresponding to a maximum similarity among the respective similarities for the plurality of categories as the target category.

In some embodiments, the to-be-processed point cloud data includes sample point cloud data, and the recognition result further includes a shape feature of the to-be-recognized object, and before obtaining the recognition result for the to-be-recognized object, the method further includes: recognizing the to-be-recognized object from the sample point cloud data to obtain target sample point cloud data corresponding to the to-be-recognized object; for each of a plurality of target planes, mapping each point in the target sample point cloud data to the target plane to obtain a respective shape representation corresponding to the target sample point cloud data, where every two of the plurality of target planes are perpendicular to each other; and obtaining the shape feature of the to-be-recognized object according to the respective shape representations for the plurality of target planes.

In some embodiments, recognizing the to-be-recognized object from the sample point cloud data to obtain the target sample point cloud data corresponding to the to-be-recognized object includes: determining a shape corresponding to the to-be-recognized object according to the sample point cloud data; acquiring first point cloud data corresponding to the to-be-recognized object from the sample point cloud data according to the shape corresponding to the to-be-recognized object; and completing the first point cloud data to obtain second point cloud data corresponding to the first point cloud data, and determining the second point cloud data as the target sample point cloud data.

In some embodiments, completing the first point cloud data to obtain the second point cloud data corresponding to the first point cloud data includes: determining a center of the shape corresponding to the to-be-recognized object, obtaining data symmetric to the first point cloud data using the center as a center of symmetry, and supplementing the first point cloud data with the data symmetric to the first point cloud data to obtain the second point cloud data.

In some embodiments, obtaining the shape feature of the to-be-recognized object according to the respective shape representations includes: fitting the respective shape representations for the plurality of target planes to obtain the shape feature of the to-be-recognized object.

In some embodiments, fitting the respective shape representations for the plurality of target planes to obtain the shape feature of the to-be-recognized object includes: fitting the respective shape representations for the plurality of target planes with a Chebyshev fitting function to obtain a nine-dimensional shape representation as the shape feature of the to-be-recognized object.

In some embodiments, the target point cloud data includes location information of each point in the target point cloud data, and the recognition result further includes location information of the to-be-recognized object.

Another aspect of the present application features an object recognition device, including: a first determining module, configured to acquire to-be-processed point cloud data, and process the to-be-processed point cloud data to obtain target point cloud data, where the to-be-processed point cloud data includes point cloud data of a to-be-recognized object; a second determining module, configured to recognize the to-be-recognized object from the target point cloud data, and determine a target feature of the to-be-recognized object; and a recognition module, configured to determine, according to the target feature, a target category to which the to-be-recognized object belongs among a plurality of categories to obtain a recognition result for the to-be-recognized object, where the recognition result includes at least the target category.

A third aspect of the present application features an object recognition device. The device includes at least one processor; and one or more memories coupled to the at least one processor and storing programming instructions for execution by the at least one processor to perform operations including: acquiring to-be-processed point cloud data, and processing the to-be-processed point cloud data to obtain target point cloud data, where the to-be-processed point cloud data includes point cloud data of a to-be-recognized object; recognizing the to-be-recognized object from the target point cloud data, and determining a target feature of the to-be-recognized object; and determining, according to the target feature, a target category to which the to-be-recognized object belongs among a plurality of categories to obtain a recognition result for the to-be-recognized object, where the recognition result includes at least the target category.

A fourth aspect of the present application features a non-transitory computer-readable storage medium coupled to at least one processor having machine-executable instructions stored thereon that, when executed by the at least one processor, cause the at least one processor to perform operations including: acquiring to-be-processed point cloud data, and processing the to-be-processed point cloud data to obtain target point cloud data, where the to-be-processed point cloud data includes point cloud data of a to-be-recognized object; recognizing the to-be-recognized object from the target point cloud data, and determining a target feature of the to-be-recognized object; and determining, according to the target feature, a target category to which the to-be-recognized object belongs among a plurality of categories to obtain a recognition result for the to-be-recognized object, where the recognition result includes at least the target category.

In an embodiment provided by the present application, before the to-be-processed point cloud data is recognized, the to-be-processed point cloud data is processed to obtain the target point cloud data, thereby reducing an impact brought by sparsity and noise in the point cloud during recognition. In addition, the category to which the object to be recognized belongs may be determined in combination with the target feature of the object to be recognized, so as to determine which of the plurality of categories the object to be recognized belongs to. That is, multiple categories of objects can be recognized to determine the category of the object to be recognized.

### BRIEF DESCRIPTION OF THE DRAWINGS

FIG. 1 is a schematic diagram of a process for implementing an object recognition method according to an embodiment of the present application.

FIG. 2 is a schematic diagram of an extraction process of shape representation according to an embodiment of the present application.

FIG. 3 is a schematic diagram of architecture of an object recognition neural network based on point cloud data according to an embodiment of the present application.

FIG. 4 is a schematic diagram of an object recognition device according to an embodiment of the present application.

### DETAILED DESCRIPTION OF THE EMBODIMENTS

To enable those skilled in the art to better understand embodiments of the present application, the embodiments of the present application will be clearly described below in conjunction with the accompanying drawings. The described embodiments are only some of the embodiments of the present application, rather than all of the embodiments.

Terms “first”, “second”, “third”, and the like in this application are used to distinguish between similar objects, and are not intended to describe a specific order or sequence. In addition, terms “include” and “have” and any variations thereof are intended to cover non-exclusive inclusions, for example, including a series of steps or units. A method, system, product, or device need not be limited to those steps or units clearly listed, but may include other steps or units that are not clearly listed or are inherent to the method, system, product, or device.

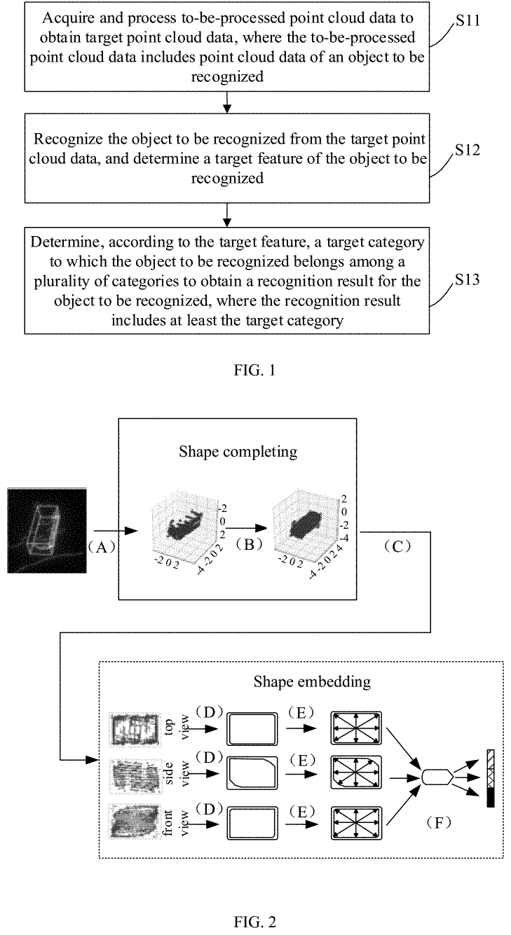

An embodiment of the present application provides an object recognition method, which can be applied to a terminal device, a server, or other electronic devices. The terminal device may include a user equipment (UE), a mobile device, a cellular phone, a cordless phone, a personal digital assistant (PDA), a handheld device, a computing device, a vehicle-mounted device, a wearable device, etc. In some possible implementations, the method may be implemented by a processor invoking computer-readable instructions stored in a memory. As shown in FIG. 1, the method mainly includes steps S11-S13.

At step S11, to-be-processed point cloud data is acquired and processed to obtain target point cloud data, where the to-be-processed point cloud data includes point cloud data of an object to be recognized. Note that the terms “object to be recognized” and “to-be-recognized object” can be used interchangeably in the present disclosure.

At step S12, the object to be recognized is recognized from the target point cloud data, and a target feature of the object to be recognized is determined.

At step S13, a target category to which the object to be recognized belongs among a plurality of categories is determined according to the target feature to obtain a recognition result for the object to be recognized, where the recognition result includes at least the target category.

In this embodiment, the to-be-processed point cloud data is a data set of at least part of points collected from an exterior surface of the object.

The method of acquiring the to-be-processed point cloud data is not limited in this embodiment. For example, the to-be-processed point cloud data may be collected by radar. For another example, the to-be-processed point cloud data may be collected by measuring instruments.

The category of the object to be recognized is not limited in this embodiment. For example, the object to be recognized may include a vehicle such as a truck, bus, car, motorcycle, and bicycle; the object to be recognized may include a building such as a tall building; or the object to be recognized may include a pedestrian.

In this embodiment, the target feature includes at least a high-level feature, for example, the high-level feature includes a semantic feature containing at least category information. In this embodiment, the target feature may also include a low-level feature, for example, the low-level feature includes a shape feature and/or a texture feature.

In this embodiment, the target category may be a true category of the object. For example, if the object to be recognized is a truck, then the corresponding target category is Truck; if the object to be recognized is a car, then the corresponding target category is Car; and if the object to be recognized is a van, then the corresponding target category is Van. However, the target category may also be a category customized by users such as data maintainers. For example, the target category includes Large vehicles, Medium vehicles, and Small vehicles. If the object to be recognized is a truck, then the target category corresponding to the truck is Large vehicle; if the object to be recognized is a car, then the target category corresponding to the car is Small vehicle; and if the object to be recognized is a van, then the target category corresponding to the van is Medium vehicle.

Embodiments of the present application may be used in various object detection tasks, and the detection scene is not limited. For example, the detection scene may include an environment perception scene, a driving assistance scene, a tracking scene, and the like.

In the embodiment provided by the present application, before the to-be-processed point cloud data is recognized, the to-be-processed point cloud data is processed to obtain the target point cloud data, thereby reducing an impact brought by sparsity and noise in the point cloud during recognition. In addition, the category to which the object to be recognized belongs may be determined in combination with the target feature of the object to be recognized, so as to determine which of the plurality of categories the object to be recognized belongs to. That is, multiple categories of objects can be recognized to determine the category of the object to be recognized.

The acquired point cloud data are only some independent scattered points, which are usually represented by three-dimensional space coordinates, and at this time, the point cloud data contains no structured information such as relative location information, Therefore, in the present application, before the acquired to-be-processed point cloud data is recognized, the to-be-processed point cloud data is processed to obtain the target point cloud data which contains structured information. In some embodiments, processing the to-be-processed point cloud data to obtain the target point cloud data may include: traversing the to-be-processed point cloud data through a target geometry at a target step length to obtain the target point cloud data; where, the target geometry has the same dimension as the to-be-processed point cloud data, and the target geometry includes a regularly-shaped geometry.

A category of the target geometry is not limited in this embodiment. For example, the target geometry may be a cylinder, a cube, a cuboid, or a sphere.

A size of the target geometry is not limited in this embodiment. The size may be set or adjusted according to requirements such as time requirements or accuracy requirements.

In this embodiment, the target step length may be set or adjusted according to requirements such as time requirements or accuracy requirements.

In some embodiments, the to-be-processed point cloud data may be scanned by moving the target geometry over the to-be-processed point cloud data at the target step length, and during the movement of the target geometry, non-overlapped point cloud data covered by the target geometry may be extracted; and the target point cloud data containing location information may be obtained according to the extracted non-overlapped point cloud data covered by the target geometry.

Assuming that the to-be-processed point cloud data includes M points, and coordinates of each point are expressed as (X, Y, Z), the points in the target point cloud data may be expressed in the form of W×H×N×(Xᵢ, Yᵢ, Zᵢ), where N indicates there are N points in each target geometry and may generally be set or adjusted according to requirements such as accuracy requirements, and W×H indicates a preset range of the point cloud. For example, if the preset range of the point cloud is 100 m×100 m, N=16, and the size of the target geometry is 0.5 m×0.5 m, the points in the target point cloud data may be expressed in the form of 100 m×100 m×16×(Xᵢ, Yᵢ, Zᵢ). Since 100 m divided by 0.5 m equals 200, the number of points in the target point cloud data obtained after scanning the preset range of the point cloud with the target geometry is 200×200×16, which can enable the points in the target point cloud data to have location information and facilitate subsequent determination of the target feature. Since the number of points included in the target geometry is fixed, the number of the points may be reduced in the process of determining the target point cloud data from the to-be-processed point cloud data, which helps to increase a speed of the subsequent determination of the target feature.

In this way, compared with the independent scattered points in the to-be-processed point cloud data, the present application traverses the to-be-processed point cloud data by the target geometry at the target step length to obtain the target point cloud data containing location information, such that the to-be-processed point cloud data without structured information may be represented as the target point cloud data containing the structured information, which helps to obtain more accurate semantic features, thereby improving the accuracy of object recognition.

Taking the scene of vehicle recognition as an example, considering that vehicles with different models have different head shapes, the category of the object may be determined by recognizing the head of the object. Therefore, in some embodiments, objects belonging to different categories have different head shapes; and determining, according to the target feature, the target category to which the object to be recognized belongs among the plurality of categories may include: determining, according to the target feature, a similarity between a head shape of the object to be recognized and a head shape corresponding to each of the plurality of categories to obtain a plurality of similarities; and determining a category corresponding to the maximum similarity among the plurality of similarities as the target category.

Thus, it is possible to determine the category to which the object to be recognized belongs by comparing the similarity between the head shape of the object to be recognized and the head shape corresponding to each of the plurality of categories, which can improve the recognition efficiency compared with analyzing all features of the object to be recognized to determine the category to which the object to be recognized belongs.

Hereinafter, a method of training a neural network used in the object recognition scheme of the present application will be described in detail.

To make the object recognition result more accurate, the shape feature of the object will be considered during learning and training of the neural network. In some embodiments, the to-be-processed point cloud data includes sample point cloud data, and the recognition result further includes the shape feature of the object to be recognized; and before obtaining the recognition result for the object to be recognized, the method may further include: recognizing the object to be recognized from the sample point cloud data to obtain target sample point cloud data corresponding to the object to be recognized; mapping each point in the target sample point cloud data to a plurality of target planes to obtain shape information corresponding to the target sample point cloud data in each of the plurality of target planes, where every two of the plurality of target planes are perpendicular to each other; and obtaining the shape feature of the object to be recognized according to a plurality of the shape information.

In this embodiment, the target plane is a two-dimensional plane. For example, the two-dimensional plane may include a plane where a front view of the object to be recognized is located, a plane where a side view of the object to be recognized is located, or a plane where a top view of the object to be recognized is located.

In this way, the object to be recognized may be represented by the shape information corresponding to the target sample point cloud data mapped to the plurality of target planes, so as to provide a shape representation of the object to be recognized, which helps to supervise the training of the neural network by the plurality of the shape information and shape annotation results in the training samples, so that the trained neural network can recognize multiple categories of objects with more accurate recognition results.

It should be noted that in practical applications, shapes viewed from different sides of the same object may be different. For example, a view projected from the front to the rear of the object is called a front view, which may reflect the shape of the front of the object; a view projected from the left to the right of the object is called a left view (side view), which may reflect the shape of the left side of the object; and a view projected from the top to the bottom of the object is called a top view, which may reflect the shape of the top of the object. To represent the shape of the object more comprehensively or completely, three target planes are usually selected for point mapping. For example, the three target planes may be the plane where the front view is located, the plane where the side view is located, and the plane where the top view is located.

To reduce an impact brought by sparsity and noise in the point cloud during recognition, the point cloud data may be completed. As an implementation, recognizing the object to be recognized from the sample point cloud data to obtain the target sample point cloud data corresponding to the object to be recognized may include: determining a shape corresponding to the object to be recognized according to the sample point cloud data; acquiring first point cloud data corresponding to the object to be recognized from the sample point cloud data according to the shape corresponding to the object to be recognized; and completing the first point cloud data to obtain second point cloud data corresponding to the first point cloud data, and determining the second point cloud data as the target sample point cloud data.

In this way, the point cloud data may be completed to make up for the problem of less or incomplete point cloud data collected on the same object, and to obtain more point cloud data, which helps to provide a more accurate shape representation of the object, and in turn to promote the generalization ability of the neural network to be trained.

In view of the fact that objects generally have central symmetry, as an implementation, completing the first point cloud data to obtain the second point cloud data corresponding to the first point cloud data may include: determining a center of the shape corresponding to the object to be recognized, and completing the first point cloud data with central symmetry using the center as a center of symmetry to obtain the second point cloud data. Completing the first point cloud data to obtain the second point cloud data can include: supplementing the first point cloud data with data to obtain the second point cloud data. The data can be data symmetric to the first point cloud data using the center as the center of symmetry.

In some examples, the center of the shape corresponding to the object to be recognized is aligned to an origin of coordinates, and the object to be recognized is rotated at the same time, and a forward direction of the object to be recognized is used as the y-axis and a vertical direction as the x-axis. Coordinates (xl, yl, zl) of a point in the first point cloud data of the object to be recognized, such as point Q, is determined, and the point Q in the first point cloud data is completed with central symmetry based on a coordinate system with the center of the object to be recognized as the origin, to obtain coordinates (xl′, yl′, zl′) of a symmetrical point Q′ of the point Q. That is, the first point cloud data includes the point Q (xl, yl, zl), and the second point cloud data includes the point Q (xl, yl, zl) and its symmetrical point Q′ (xl′, yl′, zl′).

In this way, since the radar may only scan up to three surfaces when collecting points on the surface of the object, completing the points with central symmetry here can quickly complete the sample point cloud data while making up for the sparsity in the sample point cloud data.

It can be understood that there is a corresponding center for each object to be recognized. Objects to be recognized are independent of each other, that is, each object to be recognized is independent and may be transformed to a coordinate system with its own center as the origin.

In this way, the sample point cloud data may be transformed to a coordinate system with the center of the object to be recognized as the origin, which facilitates subsequent data processing.

To efficiently and concisely represent the shape information of the object, in an embodiment, obtaining the shape feature of the object to be recognized according to the plurality of the shape information may include: fitting the plurality of the shape information to obtain the shape feature of the object to be recognized.

In some examples, according to the distribution of points in each target plane, a convex hull may be used to frame peripheral points in each target plane to obtain the shape representation of the object. Further, to better represent the convex hull, an angle-radius function is introduced to represent the convex hull. For example, the angle-radius function may be obtained by emitting a plurality of rays according to the target step length with a center of an object box as an origin, and using a distance between the origin and an intersection of the ray and the convex hull as a radius. Here, the object box is a box of the object labeled according to the sample point cloud data. The target step length, for example, may be 1°, that is, an angle between two adjacent rays is 1°, and in this case, 360 rays may be emitted. However, it can be understood that the target step length may be set or adjusted according to requirements such as accuracy requirements, and therefore, the number of rays is adjustable. For example, if the target step length is 2°, that is, the angle between two adjacent rays is 2°, then 180 rays may be emitted. For another example, if the target step length is 4°, that is, the angle between two adjacent rays is 4°, then 90 rays may be emitted.

To efficiently and concisely compress the shape representation obtained above, in some examples, a Chebyshev fitting function is established based on the angle-radius function, and the first three coefficients of the Chebyshev fitting function are determined and substituted into the shape representation in the target plane, to obtain the shape representation of each object. In this way, an efficient and concise shape representation can be obtained, thereby helping to improve the recognition efficiency.

To better recognize the shape of the object, in some embodiments, a supervision signal on the shape may be introduced, and the shape representation of the sample point cloud data in the training sample may be extracted before the training.

In some embodiments, as shown in FIG. 2, the shape representation of the sample point cloud data is extracted. FIG. 2 takes one object to be recognized as an example, that is, takes an object box corresponding to one object to be recognized as an example, to illustrate the entire implementation process, which may include the following steps A-F.

At step A, a plurality of object boxes included in the sample point cloud data may be determined based on the sample point cloud data, and points in each of the plurality of object boxes may be mapped to a coordinate system to obtain first coordinates of each object box.

Mapping the points in each of the plurality of object boxes to the coordinate system to obtain the first coordinates of each object box may include: aligning a center of the object box to an origin of coordinates, while rotating the object, and using a forward direction of the object as the y-axis and a vertical direction as the x-axis.

Here, the object box is pre-labeled before the training.

Here, the origin of coordinates is the center of the object box.

It can be understood that there is a corresponding center for each object box. Objects box are independent of each other, that is, each object box is independent and may be transformed to a coordinate system with its own center as the origin.

In this way, point cloud data in the world coordinate system may be transformed to the coordinate system with the center of the object box as the origin, which facilitates subsequent data processing.

At step B, symmetry processing may be performed on first point cloud data corresponding to the first coordinates to obtain second point cloud data corresponding to second coordinates, where the second point cloud data includes the first point cloud data.

Where, performing symmetry processing on the first point cloud data corresponding to the first coordinates to obtain the second point cloud data corresponding to the second coordinates may include: performing symmetry processing on the first point cloud data corresponding to the first coordinates with a center of each object box as a center of symmetry to obtain the second point cloud data of the second coordinates corresponding to the first coordinates.

In this way, the central symmetry processing may be used to complete the points, which makes up for the sparsity in the point cloud.

At step C, the second point cloud data, that is, the target sample point cloud data, may be projected into three views to obtain a three-view representation, where the three views may include a front view, a top view, and a side view.

In this embodiment, the target sample point cloud data in three-dimensional space may be mapped to the three views through step C, so as to obtain the representation in three two-dimensional views.

At step D, a shape of each of the three views of each object box may be extracted through a convex hull, to obtain the shape representation of each object box.

In this embodiment, since scattered points are obtained before step D, and the interior of the point cloud is mostly sparse and hollow, the convex hull is introduced at step D to extract the shape in each view, and the periphery of the scattered points is framed, which makes up for the inner-sparsity problem, and also facilitates the subsequent feature representation.

In this embodiment, to better represent the convex hull, an angle-radius function is introduced.

At step E, 360 rays may be emitted using the center of each object box as the origin of coordinates with one ray for each degree, and a distance between the origin of coordinates and an intersection of the ray and the convex hull may be used as the radius, to obtain the angle-radius function.

However, it can be understood that the number of the rays may be set or adjusted according to requirements such as accuracy requirements. For example, 180 rays may be emitted with an angle of 2° between two adjacent rays. For another example, 90 rays may be emitted with an angle of 4° between two adjacent rays.

At step F, a Chebyshev fitting function may be established based on the angle-radius function, and the first three coefficients of the Chebyshev fitting function may be determined and substituted into the three-view representation, to obtain the shape representation of each object box, where the shape representation includes three shape representations of the front view of the three views, three shape representations of the top view of the three views, and three shape representations of the side view of the three views.

In this embodiment, since the Chebyshev fitting function may obtain an infinite number of coefficients, to efficiently and concisely compress the shape representation obtained at step E above, only the first three coefficients are selected in the present application, and finally a nine-dimensional shape representation is obtained as the shape feature of the object to be recognized.

Chebyshev fitting may be defined as follows:

T₀(x)=1 (1)

T₁(x)=x (2)

Tₙ₊₁(x)=2xTₙ(x)−Tₙ₋₁(x) (3),

where, x is the independent variable, and T represents the Chebyshev formula.

According to the definition of Chebyshev fitting, a general expression may be defined as follows:

f(x)≈Σₙ₌₀^{N}αₙTₙ(x) (4)

Finally, the coefficients of Chebyshev fitting may be calculated as follows:

$${α}_{0} = \frac{1}{N + 1} {\sum }_{n = 0}^{N} f ( {x}_{n} ) {T}_{0} ( {x}_{n} ) \qquad ( 5 )$$

$${α}_{j} = \frac{2}{N + 1} {\sum }_{n = 0}^{N} f ( {x}_{n} ) {T}_{j} ( {x}_{n} ) \qquad ( 6 )$$

In some embodiments, the Chebyshev function may be established by using the angle as x in Chebyshev fitting and the radius as T in Chebyshev fitting. The coefficient α₀ may be obtained according to equation (5), the coefficients α₁ and α₂ may be obtained according to equation (6), and α₀, α₁ and α₂ may be used as the representation in each of the three views, to finally obtain a nine-dimensional shape representation.

Through the above six steps A-F, a robust and efficient shape representation may be obtained.

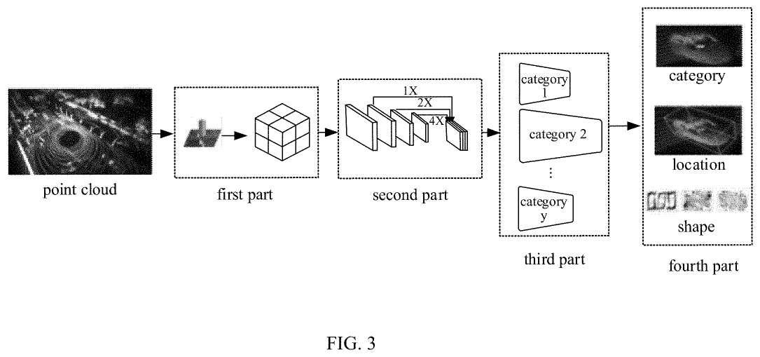

FIG. 3 is a schematic diagram of architecture of an object recognition neural network based on point cloud data according to an embodiment of the present application. As shown in FIG. 3, the entire architecture is divided into the following first to fourth parts.

The first part is configured to process the acquired original point cloud data to obtain a structured representation of the point cloud data, for example, to add relative location relationship between multiple points in the point cloud data to the original point cloud data. That is, the first part is configured to convert to-be-processed point cloud data into target point cloud data.

The second part is configured to determine a high-level feature and a low-level feature of the point cloud data according to the structured representation, where the high-level feature may include a semantic feature containing at least category information, and the low-level feature may include a shape feature and/or a texture feature. That is, the second part is configured to determine a target feature according to the target point cloud data, and may be implemented by a convolutional neural network.

The third part is configured to perform object recognition based on the high-level feature and the low-level feature to obtain a recognition result for each object involved in the point cloud data, where the recognition result may include shape, location, and category. That is, the third part is configured to determine, according to the target feature, a target category to which the object to be recognized belongs among a plurality of categories to obtain a recognition result for the object to be recognized. For example, a similarity between a head shape of the object to be recognized and a head shape corresponding to each of the plurality of categories may be determined to obtain a plurality of similarities, and a category corresponding to the maximum similarity among the plurality of similarities may be determined as the target category. The third part may be implemented by a multi-branch object recognizer based on shape clustering. The multi-branch object recognizer may deliver objects with different shapes into different branches each of which corresponds to one category.

The fourth part is the supervision signal for the object recognition neural network. The supervision signal contains three types of supervision signals on category, location and shape representation of the object. A loss function of the object recognition neural network includes the sum of a category loss, a location loss and a shape loss.

In this embodiment, the shape representation refers to the shape representation of the object. It can be understood that different categories of objects correspond to different shapes, and thus correspond to different shape representations. For example, the shape representation of a pedestrian is different from that of a car. For another example, the shape representation of a truck is different from that of a car.

In this embodiment, the location refers to the location of the object. It can be understood that the location may be represented by spatial coordinates (X, Y, Z). For example, the location of object 1 may be represented as (X1, Y1, Z1), the location of object 2 may be represented as (X2, Y2, Z2), and the location of object n may be represented as (Xn, Yn, Zn).

In this embodiment, the category refers to the category of the object. It can be understood that the category may include a plurality of major categories, each of which may include a plurality of minor categories. For example, the category may include Pedestrian, Vehicle, Building, etc., and the category of Vehicle may be divided into minor categories such as Car and Truck. It should be noted that how the category is divided and subdivided may be set or adjusted according to requirements such as accuracy requirements and time requirements.

The embodiments of the present application may be used in various object detection tasks, and the detection scene is not limited. For example, the detection scene may include an environment perception scene, a driving assistance scene, a tracking scene, and the like.

Finally, parameters of the three network components of the first part, the second part and the third part may be adjusted according to the loss function to minimize the sum of the category loss, location loss and shape loss.

In this embodiment, considering that different categories of objects have significant differences in shape when learning and training the object recognition neural network, the shape information may be embedded into the supervision signal for the network to guide the learning and training of the object recognition neural network, so that the trained neural network has the ability to recognize multiple categories of objects, and get better detection results. It should be understood that the architecture of the object recognition neural network shown in FIG. 3 is merely exemplary, and those skilled in the art may make various obvious changes and/or substitutions based on the example in FIG. 3, and the resulting embodiments still fall within the disclosed scope of the embodiments of the present disclosure.

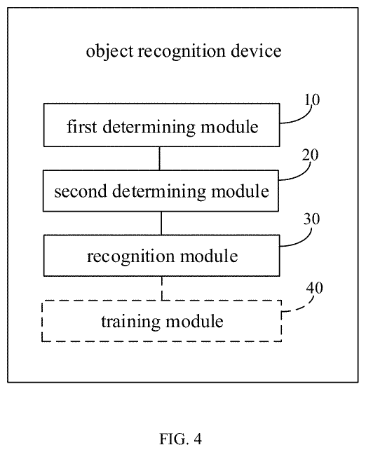

Corresponding to the above object recognition method, an embodiment of the present application provides an object recognition device. As shown in FIG. 4, the device includes a first determining module 10, a second determining module 20, and a recognition module 30.

The first determining module 10 is configured to acquire to-be-processed point cloud data, and process the to-be-processed point cloud data to obtain target point cloud data, where the to-be-processed point cloud data includes point cloud data of an object to be recognized.

The second determining module 20 is configured to recognize the object to be recognized from the target point cloud data, and determine a target feature of the object to be recognized.

The recognition module 30 is configured to determine, according to the target feature, a target category to which the object to be recognized belongs among a plurality of categories to obtain a recognition result for the object to be recognized, where the recognition result includes at least the target category.

In some embodiments, the first determining module 10 is configured to:

traverse the to-be-processed point cloud data through a target geometry at a target step length to obtain the target point cloud data,

where, the target geometry has the same dimension as the to-be-processed point cloud data, and the target geometry includes a regularly-shaped geometry.

In some embodiments, objects belonging to different categories have different head shapes; and the recognition module 30 is configured to determine, according to the target feature, a similarity between a head shape of the object to be recognized and a head shape corresponding to each of the plurality of categories to obtain a plurality of similarities; and determine a category corresponding to the maximum similarity among the plurality of similarities as the target category.

In some embodiments, the to-be-processed point cloud data includes sample point cloud data, and the recognition result may further include a shape feature of the object to be recognized; and the device may further include a training module 40.

The training module 40 is configured to:

recognize the object to be recognized from the sample point cloud data to obtain target sample point cloud data corresponding to the object to be recognized;

map each point in the target sample point cloud data to a plurality of target planes to obtain shape information corresponding to the target sample point cloud data in each of the plurality of target planes, where every two of the plurality of target planes are perpendicular to each other; and

obtain the shape feature of the object to be recognized according to a plurality of the shape information.

In some embodiments, the training module 40 is configured to:

determine a shape corresponding to the object to be recognized according to the sample point cloud data;

acquire first point cloud data corresponding to the object to be recognized from the sample point cloud data according to the shape corresponding to the object to be recognized; and

complete the first point cloud data to obtain second point cloud data corresponding to the first point cloud data, and determine the second point cloud data as the target sample point cloud data.

In some embodiments, the training module 40 is configured to: determine a center of the shape corresponding to the object to be recognized, and complete the first point cloud data with central symmetry using the center as a center of symmetry to obtain the second point cloud data.

In some embodiments, the training module 40 is configured to: fit the plurality of the shape information to obtain the shape feature of the object to be recognized.

In some embodiments, the target point cloud data may include location information of each point, and the recognition result may further include location information of the object to be recognized.

Those skilled in the art should understand that the implementation function of each processing module in the object recognition device shown in FIG. 4 may be understood with reference to the relevant description of the aforementioned object recognition method. Those skilled in the art should understand that the function of each processing module in the object recognition device shown in FIG. 4 may be implemented by a program running in a processor, or may be implemented by a specific logic circuit.

In practical applications, the above-mentioned first determining module 10, second determining module 20, recognition module 30, and training module 40 may each correspond to a processor. The processor may be a central processing unit (CPU), a micro controller unit (MCU), a digital signal processor (DSP), or a programmable logic controller (PLC) and other electronic components with processing functions or collections of the electronic components. Where, the processor includes executable codes stored in a storage medium, and the processor may be connected to the storage medium through a communication interface such as a bus, so as to read and run the executable codes from the storage medium when executing the corresponding function of each module. A part of the storage medium used to store the executable codes is preferably a non-transitory storage medium.

The object recognition device provided in the embodiments of the present application can recognize multiple categories of objects with more accurate recognition results, and can be applied to a wider range of fields.

An embodiment of the present application further provides an object recognition device. The device includes a memory, a processor, and a computer program stored in the memory and executable in the processor, where the computer program, when executed by the processor, enables the processor to implement the object recognition method provided in any one of the foregoing embodiments.

As an implementation, the computer program, when executed by the processor, enables the processor to: acquire to-be-processed point cloud data, and process the to-be-processed point cloud data to obtain target point cloud data, where the to-be-processed point cloud data includes point cloud data of an object to be recognized; recognize the object to be recognized from the target point cloud data, and determine a target feature of the object to be recognized; and determine, according to the target feature, a target category to which the object to be recognized belongs among a plurality of categories to obtain a recognition result for the object to be recognized, where the recognition result includes at least the target category.

As an implementation, the computer program, when executed by the processor, enables the processor to traverse the to-be-processed point cloud data through a target geometry at a target step length to obtain the target point cloud data, where the target geometry has the same dimension as the to-be-processed point cloud data, and the target geometry includes a regularly-shaped geometry.

As an implementation, objects belonging to different categories have different head shapes; and the computer program, when executed by the processor, enables the processor to: determine, according to the target feature, a similarity between a head shape of the object to be recognized and a head shape corresponding to each of the plurality of categories to obtain a plurality of similarities; and determine a category corresponding to the maximum similarity among the plurality of similarities as the target category.

As an implementation, the to-be-processed point cloud data includes sample point cloud data, and the recognition result further includes the shape feature of the object to be recognized; and the computer program, when executed by the processor, enables the processor to: before obtaining the recognition result for the object to be recognized, recognize the object to be recognized from the sample point cloud data to obtain target sample point cloud data corresponding to the object to be recognized; map each point in the target sample point cloud data to a plurality of target planes to obtain shape information corresponding to the target sample point cloud data in each of the plurality of target planes, where every two of the plurality of target planes are perpendicular to each other; and obtain the shape feature of the object to be recognized according to a plurality of the shape information.

As an implementation, the computer program, when executed by the processor, enables the processor to: determine a shape corresponding to the object to be recognized according to the sample point cloud data; acquire first point cloud data corresponding to the object to be recognized from the sample point cloud data according to the shape corresponding to the object to be recognized; and complete the first point cloud data to obtain second point cloud data corresponding to the first point cloud data, and determine the second point cloud data as the target sample point cloud data.

As an implementation, the computer program, when executed by the processor, enables the processor to: determine a center of the shape corresponding to the object to be recognized, and complete the first point cloud data with central symmetry using the center as a center of symmetry to obtain the second point cloud data.

As an implementation, the computer program, when executed by the processor, enables the processor to fit the plurality of the shape information to obtain the shape feature of the object to be recognized.

As an implementation, the target point cloud data includes location information of each point, and the recognition result further includes location information of the object to be recognized.

The object recognition device provided in the embodiments of the present application can recognize multiple categories of objects with more accurate recognition results, and can be applied to a wider range of fields.

An embodiment of the present application further provides a computer storage medium in which computer-executable instructions/computer programs are stored, and the computer-executable instructions are used to execute the object recognition method described in each of the foregoing embodiments. In other words, the computer-executable instructions, when executed by a processor, may enable the processor to implement the object recognition method provided in any one of the foregoing embodiments.

An embodiment of the present application further provides a computer program that, when executed by a processor, enables the processor to implement the object recognition method provided in any one of the foregoing embodiments.

Those skilled in the art should understand that the functions of the computer programs in the embodiments of the present application may be understood with reference to the relevant description of the object recognition method described in each of the foregoing embodiments.

Those ordinary skilled in the art can understand that all or part of the steps in the above method embodiments may be implemented by hardware related to program instructions. The foregoing program may be stored in a computer-readable storage medium, and the steps in the above method embodiments may be performed when the program is executed. The aforementioned storage medium may include a removable storage device, read-only memory (ROM), random access memory (RAM), magnetic disk or optical disk, and various other media that can store program codes.

Alternatively, when the embodiments of the present application are implemented in the form of software functional modules and sold or used as independent products, they may also be stored in a computer-readable storage medium. Based on this understanding, the embodiments of the present application may essentially be embodied in the form of a computer software product. The computer software product is stored in a storage medium and includes several instructions to enable a computer device (which may be a personal computer, a server, or a network device, etc.) to perform all or part of the method described in each embodiment of the present application. The aforementioned storage medium may include a removable storage device, ROM, RAM, magnetic disk, or optical disk and various other media that can store program codes.

The above are only specific implementations of the present application, but the protection scope of the present application is not limited thereto. Any variation or replacement readily conceivable by those skilled in the art within the technical scope disclosed in the present application shall be covered by the protection scope of the present application. Therefore, the protection scope of the present application should be subject to the protection scope of the appended claims.

1. A computer-implemented method for object recognition, comprising:
acquiring to-be-processed point cloud data, and processing the to-be-processed point cloud data to obtain target point cloud data, wherein the to-be-processed point cloud data comprises point cloud data of a to-be-recognized object;
recognizing the to-be-recognized object from the target point cloud data, and determining a target feature of the to-be-recognized object; and
determining, according to the target feature, a target category to which the to-be-recognized object belongs among a plurality of categories to obtain a recognition result for the to-be-recognized object, wherein the recognition result comprises at least the target category.

2. The computer-implemented method of claim 1, wherein processing the to-be-processed point cloud data to obtain the target point cloud data comprises:
traversing the to-be-processed point cloud data through a target geometry at a target step length to obtain the target point cloud data,
wherein the target geometry has a same dimension as the to-be-processed point cloud data, and the target geometry comprises a regularly-shaped geometry.

3. The computer-implemented method of claim 2, wherein traversing the to-be-processed point cloud data through the target geometry at the target step length to obtain the target point cloud data comprises:
scanning the to-be-processed point cloud data by moving the target geometry over the to-be-processed point cloud data at the target step length;
during the movement of the target geometry, extracting non-overlapped point cloud data covered by the target geometry; and
obtaining the target point cloud data according to the extracted non-overlapped point cloud data covered by the target geometry.

4. The computer-implemented method of claim 1, wherein objects belonging to different categories have different head shapes, and
wherein determining, according to the target feature, the target category to which the to-be-recognized object belongs among the plurality of categories comprises:
for each of the plurality of categories, determining, according to the target feature, a similarity between a head shape of the to-be-recognized object and a head shape corresponding to the category to obtain a respective similarity; and
determining a category corresponding to a maximum similarity among the respective similarities for the plurality of categories as the target category.

5. The computer-implemented method of claim 1, wherein the to-be-processed point cloud data comprises sample point cloud data, and the recognition result further comprises a shape feature of the to-be-recognized object, and
wherein before obtaining the recognition result for the to-be-recognized object, the method further comprises:
recognizing the to-be-recognized object from the sample point cloud data to obtain target sample point cloud data corresponding to the to-be-recognized object;
for each of a plurality of target planes, mapping each point in the target sample point cloud data to the target plane to obtain a respective shape representation corresponding to the target sample point cloud data, wherein every two of the plurality of target planes are perpendicular to each other; and
obtaining the shape feature of the to-be-recognized object according to the respective shape representations for the plurality of target planes.

6. The computer-implemented method of claim 5, wherein recognizing the to-be-recognized object from the sample point cloud data to obtain the target sample point cloud data corresponding to the to-be-recognized object comprises:
determining a shape corresponding to the to-be-recognized object according to the sample point cloud data;
acquiring first point cloud data corresponding to the to-be-recognized object from the sample point cloud data according to the shape corresponding to the to-be-recognized object; and
completing the first point cloud data to obtain second point cloud data corresponding to the first point cloud data, and determining the second point cloud data as the target sample point cloud data.

7. The computer-implemented method of claim 6, wherein completing the first point cloud data to obtain the second point cloud data corresponding to the first point cloud data comprises:
determining a center of the shape corresponding to the to-be-recognized object,
obtaining data symmetric to the first point cloud data using the center as a center of symmetry, and
supplementing the first point cloud data with the data symmetric to the first point cloud data to obtain the second point cloud data.

8. The computer-implemented method of claim 5, wherein obtaining the shape feature of the to-be-recognized object according to the respective shape representations comprises:
fitting the respective shape representations for the plurality of target planes to obtain the shape feature of the to-be-recognized object.

9. The computer-implemented method of claim 8, wherein fitting the respective shape representations for the plurality of target planes to obtain the shape feature of the to-be-recognized object comprises:
fitting the respective shape representations for the plurality of target planes with a Chebyshev fitting function to obtain a nine-dimensional shape representation as the shape feature of the to-be-recognized object.

10. The computer-implemented method of claim 1, wherein the target point cloud data comprises location information of each point in the target point cloud data, and the recognition result further comprises location information of the to-be-recognized object.

11. An object recognition device, comprising:
at least one processor; and
one or more memories coupled to the at least one processor and storing programming instructions for execution by the at least one processor to perform operations comprising:
acquiring to-be-processed point cloud data, and processing the to-be-processed point cloud data to obtain target point cloud data, wherein the to-be-processed point cloud data comprises point cloud data of a to-be-recognized object;
recognizing the to-be-recognized object from the target point cloud data, and determining a target feature of the to-be-recognized object; and
determining, according to the target feature, a target category to which the to-be-recognized object belongs among a plurality of categories to obtain a recognition result for the to-be-recognized object, wherein the recognition result comprises at least the target category.

12. The object recognition device of claim 11, wherein processing the to-be-processed point cloud data to obtain the target point cloud data comprises:
traversing the to-be-processed point cloud data through a target geometry at a target step length to obtain the target point cloud data,
wherein the target geometry has a same dimension as the to-be-processed point cloud data, and the target geometry comprises a regularly-shaped geometry.

13. The object recognition device of claim 12, wherein processing the to-be-processed point cloud data to obtain the target point cloud data comprises:
scanning the to-be-processed point cloud data by moving the target geometry over the to-be-processed point cloud data at the target step length;
during the movement of the target geometry, extracting non-overlapped point cloud data covered by the target geometry; and
obtaining the target point cloud data according to the extracted non-overlapped point cloud data covered by the target geometry.

14. The object recognition device of claim 11, wherein objects belonging to different categories have different head shapes, and
wherein determining, according to the target feature, the target category to which the to-be-recognized object belongs among the plurality of categories comprise:
for each of the plurality of categories, determining, according to the target feature, a similarity between a head shape of the to-be-recognized object and a head shape corresponding to the category to obtain a respective similarity; and
determining a category corresponding to a maximum similarity among the respective similarities for the plurality of categories as the target category.

15. The object recognition device of claim 11, wherein the to-be-processed point cloud data comprises sample point cloud data, and the recognition result further comprises a shape feature of the to-be-recognized object, and
wherein, before obtaining the recognition result for the to-be-recognized object, the operations further comprise:
recognizing the to-be-recognized object from the sample point cloud data to obtain target sample point cloud data corresponding to the to-be-recognized object;
for each of a plurality of target planes, mapping each point in the target sample point cloud data to the target plane to obtain a respective shape representation corresponding to the target sample point cloud data, wherein every two of the plurality of target planes are perpendicular to each other; and
obtaining the shape feature of the to-be-recognized object according to the respective shape representations for the plurality of target planes.

16. The object recognition device of claim 15, wherein recognizing the to-be-recognized object from the sample point cloud data to obtain the target sample point cloud data corresponding to the to-be-recognized object comprises:
determining a shape corresponding to the to-be-recognized object according to the sample point cloud data;
acquiring first point cloud data corresponding to the to-be-recognized object from the sample point cloud data according to the shape corresponding to the to-be-recognized object; and
completing the first point cloud data to obtain second point cloud data corresponding to the first point cloud data, and determining the second point cloud data as the target sample point cloud data.

17. The object recognition device of claim 16, wherein completing the first point cloud data to obtain the second point cloud data corresponding to the first point cloud data comprises:
determining a center of the shape corresponding to the to-be-recognized object;
obtaining data symmetric to the first point cloud data using the center as a center of symmetry; and
supplementing the first point cloud data with the data symmetric to the first point cloud data to obtain the second point cloud data.

18. The object recognition device of claim 15, wherein obtaining the shape feature of the to-be-recognized object according to the respective shape representations comprises:
fitting the respective shape representations for the plurality of target planes to obtain the shape feature of the to-be-recognized object.

19. The object recognition device of claim 11, wherein the target point cloud data comprises location information of each point in the target point cloud data, and the recognition result further comprises location information of the to-be-recognized object.

20. A non-transitory computer-readable storage medium coupled to at least one processor having machine-executable instructions stored thereon that, when executed by the at least one processor, cause the at least one processor to perform operations comprising:
acquiring to-be-processed point cloud data, and processing the to-be-processed point cloud data to obtain target point cloud data, wherein the to-be-processed point cloud data comprises point cloud data of a to-be-recognized object;
recognizing the to-be-recognized object from the target point cloud data, and determining a target feature of the to-be-recognized object; and
determining, according to the target feature, a target category to which the to-be-recognized object belongs among a plurality of categories to obtain a recognition result for the to-be-recognized object, wherein the recognition result comprises at least the target category.
